(19) United States
(12) Patent Application Publication
(10) Pub. No.: US 2002/0002707 A1
(43) Pub. Date: Jan. 3, 2002

(54) System and method to display remote content

(76) Inventors: Sylvain G. Ekel, Seattle, WA (US); Tuan Q. Do, Bellevue, WA (US); Henry L. Meuret III, Seattle, WA (US)

Correspondence Address: BLACK LOWE & GRAHAM, 816 SECOND AVE., SEATTLE, WA, 98104, US

(21) Appl. No.: 09/895,107

(22) Filed: Jun. 29, 2001

Related U.S. Application Data
(60) Provisional application No. 60/215,169, filed on Jun. 29, 2000.

(51) Int. Cl. H04N 7/173

(52) U.S. Cl. 725/87

(57) ABSTRACT

A remote controller is configured to communicate over a wireless connection with one or more remote computers over a network to obtain audio, video, or other content. The controller is also configured to communicate with a remote display to present the content on the remote display. In some embodiments, the content may be stored in or created on the controller in addition to, or instead of, retrieval from a remote computer.

### PRIORITY CLAIM

This application claims priority from U.S. Provisional Application Serial No. 60/215,169 filed Jun. 29, 2000, Attorney Reference No. RKMH-1-1001.

### FIELD OF THE INVENTION

This invention relates generally to remote control devices and, more specifically, to microprocessor-based devices for controlling the display of remote content.

### BACKGROUND OF THE INVENTION

There have been numerous advances in the ability to conduct multimedia presentations using computers. It is becoming increasingly possible to include graphics, animation, video, and music in a computer-based presentation. Such content can be presented on a computer monitor, flat screen display, LCD projector, or other display device.

In addition, it is now possible to produce and store rich content containing animation, video, sound, and other complex elements on a computer remote from the presentation location. The Internet and other networking systems allow communication between a computer at the presentation location and a remote computer storing the presentation content.

While advances in the ability to create, store, and deliver rich content have been steady, the ability to control it in a presentation environment has lagged. Today, computer-based presentations are typically controlled using a notebook or other computer directly wired to a projector or other display device. The notebook computer is directly wired to the display and to a network port or telephone jack. The size and weight of the computer and the many wires involved combine to restrict the mobility of the presenter. Consequently, there is a need for an improved device capable of remotely controlling content to be presented on a display, including content retrieved from a remote computer.

### SUMMARY OF THE INVENTION

The present invention comprises a system for remotely controlling the presentation of content using a computer. In one form, the system includes a controller having a microprocessor, memory, user interface, and display. The controller also includes a transceiver allowing it to communicate with a remote display. Accordingly, the controller can send content from the controller for presentation on the remote display.

In accordance with further aspects of the invention, an additional transceiver enables the controller to access a remote computer over a network such as the Internet. The controller is able to access the remote computer to obtain the content, which it then sends to the remote display for presentation. In this fashion, the controller is able to retrieve any visual or audio content accessible over the Internet and send it to a remote display for presentation.

In accordance with other aspects of the invention, the controller is preferably a hand-held device. In one embodiment, a personal digital assistant is used for the controller.

In accordance with still further aspects of the invention, the content is displayed on the controller display substantially contemporaneously with the presentation on the remote display.

In accordance with yet other aspects of the invention, the controller display may not be capable of presenting the content in its entirety if the content includes video, animation, or other complex subject matter. In such embodiments, the controller presents a portion of the content on the controller display. The “portion” of the content may mean a reduction in size, a selection of particular components, or a simplified representation of the full content.

In accordance with still another aspect of the invention, the content is sent wirelessly from the controller to the display. While any format may be used, in one embodiment it is sent using a Bluetooth standard protocol.

In accordance with still further aspects of the invention, the content may be sent to more than one display at once. Alternatively, the content may include audio data that is sent to an MP3 player, computer, stereo, or other device capable of playing audio files.

In accordance with yet another aspect of the invention, the content may be created on the controller in addition to, or instead of, retrieving it from a remote computer. Accordingly, characters or other text may be typed into or drawn on a touch-sensitive screen on the controller. The data entered on the controller is substantially contemporaneously sent to the remote display for presentation. If the entered data is the only content, the controller serves as a mobile interface for a “virtual” whiteboard. If additional content is used, a user can select, hi-light, or otherwise mark-up the content being presented on the display.

### BRIEF DESCRIPTION OF THE DRAWINGS

The preferred and alternative embodiments of the present invention are described in detail below with reference to the following drawings.

FIG. 1 is a schematic view of a preferred embodiment of the remote display control invention;

FIG. 2 is an illustration of a preferred controller in accordance with this invention;

FIG. 3 is a block diagram of a display and display processor in accordance with this invention; and

FIG. 4 is a block diagram of a remote display control system in accordance with a preferred embodiment of this invention.

### DETAILED DESCRIPTION OF THE PREFERRED EMBODIMENT

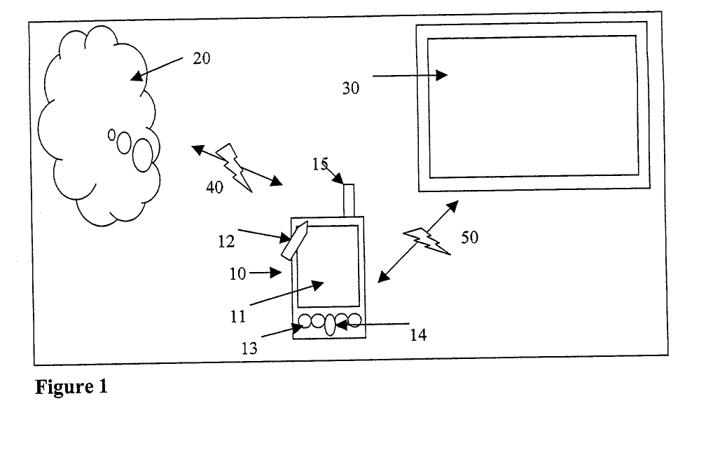

FIG. 1 depicts a remote controller arranged in accordance with the preferred embodiment. In the embodiment of FIG. 1, a controller 10 is configured to communicate over a first wireless connection 40 with one or more remote computers over a network 20. The controller 10 is also configured to communicate over a second wireless connection 50 with a display 30. In general, the controller 10 retrieves content from the network 20 for presentation on the display 30. The display 30 is “remote” from the controller in that it is not the principal display attached to the controller 10. Though the display 30 may also be somewhat distant from the controller 10, it is not necessarily so.

The Controller

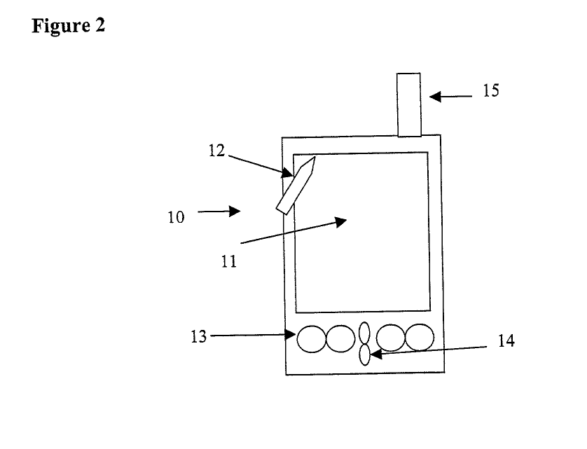

The controller includes a microprocessor, memory, and power source (not shown). In an actual embodiment, a personal digital assistant (PDA) is used as the controller. PDAs are readily available from companies such as Compaq, Palm®, and MiTAC International. As best shown in FIG. 2, the PDA-based controller 10 includes a touch-sensitive display screen 11 capable of displaying graphical and text information. The operation of the controller 10 is determined by the user's interaction with the graphical interface that is presented on the controller display screen 11. Thus, by touching the stylus 12 to icons, radio buttons, URLs, or other depictions on the display screen 11, the user causes the controller to perform one or more operations based upon commands stored in the controller memory. A PDA is a particularly good choice for the controller 10, because most PDAs include a graphical keyboard and number pad that can be displayed on the screen 11. Numbers, letters, or other symbols are entered by using the stylus to touch the letters or symbols on the keyboard or the numbers on the number pad. Alternatively, software provided with the PDA interprets hand-written characters drawn on the screen 11 using the stylus 12. In addition to, or instead of, the stylus and touch screen, the user interface may comprise a mouse, trackball, keyboard, or any other device.

One or more buttons 13 on the housing of the controller 10 generally adjacent the perimeter of the screen 11 are also provided. In an off the shelf PDA, these buttons typically are pre-programmed to cause the PDA to display stored contact lists, to-do lists, calendars, or other data. The buttons can alternatively be used to start an Internet browser or other application software. In addition, a scroller 14 is provided. The scroller causes the content shown on the display screen 11 to scroll up or down. As shown, the scroller 14 comprises an up button and a down button for scrolling up and down, respectively. Alternatively, the scroller 14 can be in the form of a wheel, joystick, or other structure.

The controller 10 includes a transponder, antenna and other circuitry (not shown) to enable it to communicate wirelessly with other devices such as the display 30. Preferably, the wireless connection 50 to the display 30 uses Bluetooth wireless technology, a de facto standard and specification for small-form factor, low-cost, short range radio links between mobile PCs, mobile phones, and other portable devices. Bluetooth is preferred because Bluetooth components are readily available for use with a variety of devices, including PDAs. One commercially available Bluetooth PDA is made by MiTAC International Corp. of Fremont, Calif.. While Bluetooth is the preferred communication standard, other formats and frequency ranges could also be used.

The controller 10 is also configured to enable it to communicate wirelessly over the Internet 20. PDAs containing an antenna 15, Internet browser software, and other associated components are readily available from companies such as Palm, Inc. The wireless connection 40 to the Internet is preferably via a cell phone network and therefore differs from the shorter wireless connection 50 between the controller 10 and the display 30.

Although a PDA is preferred for use as a controller because PDAs are readily available and can be programmed to perform tailored functions, the controller could alternatively be constructed specifically for use as a controller. Consequently, any microprocessor-based device will suffice so long as it can connect to a network and to a remote display. Likewise, wireless connections are preferred because they allow unrestrained mobility of the controller. Nonetheless, the controller 10 could communicate with the network 20 and the display 30 using wired, rather than wireless, connections. Thus, for example, the controller 10 could take the form of a notebook computer configured with a Bluetooth PCMCIA card and a modem, Ethernet card, or other connection to the Internet.

The Display

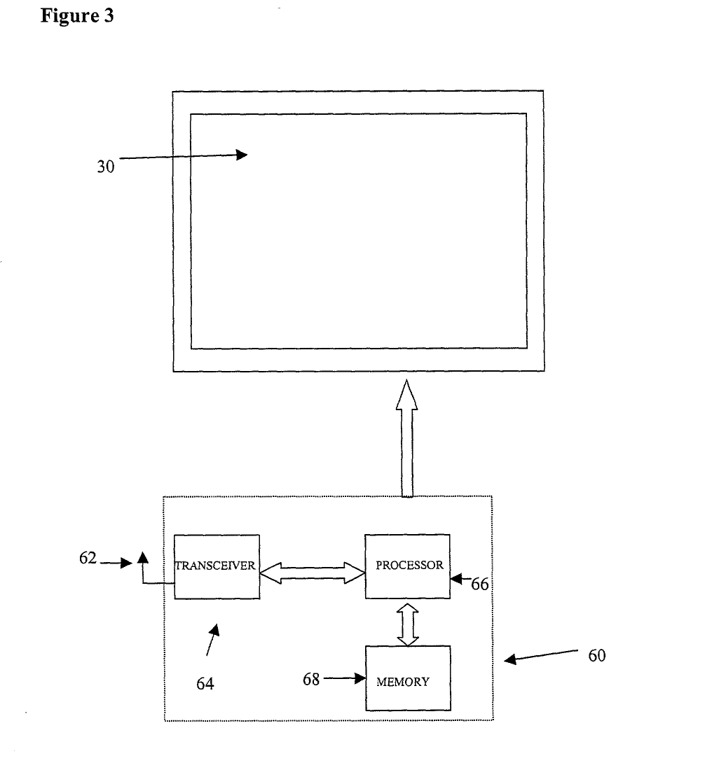

The display 30 presents multimedia or other content under the control of the controller. Signals sent from the controller 10 are received by a display processor 60. As shown in FIG. 3, the display processor 60 includes an antenna 62, a transceiver 64, a microprocessor 66, and a memory 68. The display 30 is a CRT, flat panel LCD screen, LCD projection, or other device coupled to the processor 66 and capable of presenting images.

In an actual embodiment, the display processor 60 is a notebook computer. The notebook computer is equipped with a PCMCIA card and associated software stored in the memory 68 that enables the computer to communicate with the controller 10. Bluetooth qualified hardware interfaces and supporting software are available commercially. A listing of such hardware and software is provided on the Bluetooth Internet site. The notebook computer processes instructions and data received by the Bluetooth PC card and causes the display 30 to present desired content. In this embodiment, the display 30 is an LCD screen included with the notebook computer. The notebook computer also includes external ports to drive a monitor, LCD projector, or other devices capable of presenting the computer images. If such external devices are connected to the appropriate port, any of them can serve as the display 30.

The display processor 60 need not include all of the components typically found in a notebook computer. Rather, it can include fewer components, such as those shown in FIG. 3. This can be advantageous when the display 30 is a television. Although a computer can be configured to generate an output signal that can be displayed on a television, using a computer for that purpose may be inefficient. In an alternate embodiment, the display processor 60 is specifically constructed as a set-top box or other such device that can receive signals from the controller 10 and present them on the display 30. In another alternate embodiment, the components of the display processor 60 are contained within the display 30, rather than in an external box or other housing. In yet another embodiment, the display 30 is an additional PDA or other hand-held device.

Display Content

The content presented on the display 30 can comprise any graphical, text, multimedia, or other content that may be displayed on a computer monitor, television, or other form of display. In the preferred embodiment, the content is retrieved from a remote computer over the network 20 in a manner described in detail below. In an alternative embodiment, the display content is stored in the memory associated with the controller 10 and sent to the display 30 in a session that does not require access to the network 20. In yet another embodiment, the content is stored in the memory 68 associated with the display processor 60 and presented on the display in response to commands from the controller 10.

The content presented on the controller display 11 is a duplicate of the content presented on the remote display 30. Consequently, a user can remotely see the images on the display 30 and use the controller 10 to control them. Depending on the screen size, processing power and other variables associated with the controller 10, the controller may not be able to present an exact copy of the content on the display 30. Instead, the controller display 11 will present a simplified representation of the rich content version presented on the display 30. Any of a variety of techniques are used to present content on the controller screen 11, such as avoiding the display of graphics, sound, animation, or objects larger than a specified size. Some alternative techniques presently employed to present simplified content on PDA screens are provided in commercially available products such as the PalmOS clipping representation or a Wireless Application Protocol (WAP) representation. WAP is a communications protocol and application environment that can be built on any operating system including PalmOS, EPOC, Windows CE, FLEXOS, OS/9, JavaOS, and others.

Remote Display Controller Operation

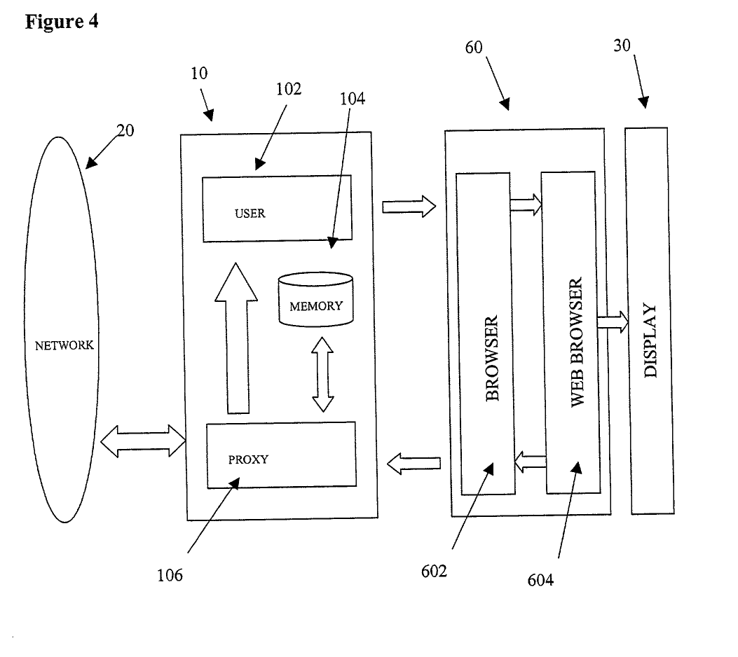

FIG. 4 illustrates the operation of this invention in the embodiment in which the controller 10 obtains and forwards content to the display 30. In general, Uniform Resource Locators (URLs) are entered into the controller 10 by the user and forwarded to the display processor 60. The display processor makes Internet requests using standard browser software. The requests are passed back to a proxy server within the controller 10, which forwards the requests over the controller connection 40 to the network 20.

In order to begin a session for displaying Internet content on the display 30, the process begins by entering a URL into the controller 10. The controller 10 includes a user interface 102 that allows a URL to be entered in any of several different ways, such as by typing it, selecting it from stored favorites, or clicking a link.

After the URL is entered, application software within the controller 10 causes the URL to be sent to the display processor 60 using sockets or a virtual Corn port via a wireless communication link 50.

The URL is received by a browser host application 602. The browser host 602 serves as an interface to a browser 604 to control operation of the browser 604. Browser software typically includes a variety of components, such as menus, toolbars, status bars, and other user interface features. These components are not required in the display processor because the user interface is placed in the controller 10. By imposing a browser host, these unnecessary are either removed, not used, or not displayed on the display 30. In an alternate embodiment, the browser host does nothing more than receive the URL or other commands from the controller 10 and passes them to the browser 604 in a manner that allows the browser 604 to understand them. In such an embodiment, all typical browser features remain and are presented on the display 30, even if they are not used.

The browser 604 receives the URL from the browser host 602, and processes it to make requests for Internet protocols as necessary to establish a connection over the network 20 to the remote computer associated with the particular URL. The Internet requests generated by the browser 604 are sent back to the controller 10 where they are received by a proxy server 106. The proxy server 106 receives the Internet requests and forwards them along to the network 20.

The Internet requests ultimately establish communication between the controller 10 and the remote computer associated with the entered URL. Once a link to the remote computer is establish, content is forwarded to the controller 10 in the form of HTML presentations, JAVA applets, or any other format that may be delivered over the network 20. The proxy server 106 receives the incoming content and forwards it to the user interface 102 where it is evaluated for possible presentation on the controller screen 11. Depending on the content received, the capabilities of the controller 10, and the techniques employed by the user interface 102, the display screen 11 will present some, all, or none of the incoming content. Preferably, Internet links contained within the incoming content are retained and presented on the display screen 11 so that the user can select them to obtain additional content.

A local memory 104 within the controller 10 stores user preferences and other client information commonly referred to as “cookies.” After the connection to the remote computer is established, the controller 10 retrieves the cookies or other stored preferences from the memory 104 and uses them to create a dynamic web page. The cookies and the dynamic web page are then sent to the display processor 60, which causes the content to be presented on the display 30 under control of the browser 604. Accordingly, the controller 10 receives content from a remote computer over the network 20, and presents it on the display 30 while presenting the same or a simplified version of the content on the controller screen 11.

Storing user preferences and cookies on the controller 10 provides advantages over storing them in a memory associated with the display 30 or display processor 60. By maintaining them in the controller 10, a user can take the controller to any remote location, establish communication with the network 20, and send content to a display 30, all while maintaining pre-established user preferences.

As described above, the controller 10 can be used to access any content on a remote computer accessible over a network, and present the content on a remote display 30 as well as the controller display screen 11. Thus, the controller 10 can be used to remotely control a network-based multimedia presentation on a display. It may also be used to “surf” the Internet or retrieve any other content over a network.

In addition to retrieving and presenting content, the controller 10 can control other aspects of the display 30. Thus, stored program instructions within the display memory 104 allow the user interface 102 to present a variety of possible commands for monitoring the display. For example, a user can enter commands into the controller to instruct the display to adjust its volume, color, contrast, brightness, input source, or any other function such as those typically monitored by a multimedia remote. In addition, Bluetooth or other local wireless protocols enable the controller 10 to command other devices in addition to the display 30. Thus, by entering appropriate commands into the user interface of the controller 10, a user can use the controller 10 to control the operation of a video recorder, printer, stereo, or other electronic device.

Many of the functions described above with reference to FIG. 4 could be moved from the controller 10 to the display processor 60 or vice versa. For example, the proxy server could be moved from the controller to the display processor. In such an embodiment, the controller issues commands that are processed generally as described above, but the communication link to the network does not go through the controller 10. In addition, the incoming content is processed through the browser 604 in the first instance and sent to the controller 10 to prepare a simplified version for display on the controller screen 11.

As another alternative, the browser functions are moved entirely to the controller 10. In such an embodiment, the controller sends to the display (or the display processor, as appropriate) a signal for presentation on the display 30 without requiring a browser. Such an embodiment may be useful, for example, when the display 30 is a standard television. In order to facilitate such an embodiment, either the controller 10 or the display processor 60 will include additional hardware or software for converting the digital computer signals to an NTSC or other television format.

In the embodiment described with reference to FIGS. 1 and 4, the content presented on the display 30 is retrieved from a remote computer over a network 20. In an alternate embodiment, the content is stored in the controller memory 104 or is created on the controller 10.

Broadcast Operation

The controller 10 can also interact with other devices in addition to or instead of the display 30. In accordance with a standard Bluetooth protocol, in response to an input provided by the user, the controller 10 requests all other Bluetooth devices within range to provide an address. The controller 10 then sends a connection request to a user-specified device and waits for an answer. When the answer is received, connection is established. The controller 10 is then able to send content to the remote device. In accordance with this embodiment, the controller 10 can, for example, obtain a music data file from a remote computer and direct that it be played on a Bluetooth-enabled computer, stereo, MP3 player, or other device. In addition, the controller 10 can send content to multiple devices at the same time.

Remote White Board Operation

In yet another embodiment, the display 30 can display content contemporaneously created on the controller 10, rather than obtained from a remote computer on the network 20. The stylus or other input device is used to create content within the controller that is contemporaneously sent to the display 30 in the same wireless manner as with other content.

Thus, in this manner, the controller 10 can be used as a remote “white board” controller, reproducing on the display 30 the sketches, characters, or other information entered by the user. The controller can also be used in this manner to allow the controller to draw over the top of a presentation being delivered from the network 20. Accordingly, the user can circle, hi-light, line-through, or otherwise add markings to other multimedia content being presented on the display 30.

While the preferred embodiment of the invention has been illustrated and described above, many changes can be made without departing from the spirit and scope of the invention. Accordingly, the scope of the invention is not limited by the disclosure of the preferred embodiment, but rather should be determined entirely by reference to the claims that follow.

The embodiments of the invention in which an exclusive property or privilege is claimed are defined as follows:

1. A controller for controlling the presentation of content on a remote display, the controller comprising:
a microprocessor;
a controller display;
a user interface;
a peripheral transceiver; and
a memory containing stored programming instructions that, when executed by the microprocessor, cause the controller to send the content to the remote display via the peripheral transceiver.

2. The controller of claim 1, further comprising a network transceiver and wherein the memory contains stored programming instructions that, when executed by the microprocessor, cause the controller to retrieve the content from a remote computer via the network transceiver.

3. The controller of claim 2, wherein the stored programming instructions, when executed by the microprocessor, cause the controller display to present the content substantially contemporaneously as the content is sent to the remote display.

4. The controller of claim 3, wherein the content presented on the controller display is a simplified version of the content presented on the remote display.

5. The controller of claim 4, wherein the peripheral transceiver is a Bluetooth transceiver.

6. The controller of claim 5, wherein the network transceiver is configured to provide a communication link to the Internet and wherein the remote computer is accessible via the Internet.

7. The controller of claim 6, wherein the memory stores user preference data.

8. The controller of claim 6, wherein a communication link between the remote computer and the controller is established in response to an address entered by the user via the user interface.

9. The controller of claim 8, wherein the address is a Uniform Resource Locator.

10. The controller of claim 8, wherein the content comprises an audio portion and a video portion.

11. The controller of claim 1, wherein the content is entered by the user via the user interface.

12. The controller of claim 11, wherein the user interface comprises a stylus and wherein the controller display is a touch-sensitive display.

13. The controller of claim 1, wherein the content is stored in the controller memory.

14. The controller of claim 10, wherein the controller is a hand-held device.

15. A controller for controlling the presentation of content on a remote display, the controller comprising:
a means for obtaining the content from a remote computer; and
a means for sending the content for presentation on the remote display.

16. The controller of claim 15, further comprising a means for displaying at least a portion of the content on the controller.

17. The controller of claim 16, further comprising a means for storing user preference data.

18. The controller of claim 17, further comprising a means for creating the content on the controller for presentation on the remote display.

19. A method for displaying content on a remote display, the method comprising:
a) accessing a remote computer over a network via a microprocessor-based controller;
b) obtaining the content from the remote computer;
c) sending the content to the remote display; and
d) presenting the content on the remote display.

20. The method of claim 19, wherein the step of accessing the remote display further comprises entering into the controller an address associated with the remote computer.

21. The method of claim 20, further comprising the step of presenting at least a portion of the content on a display connected to the remote controller.
